(19) United States
(12) Patent Application Publication
(10) Pub. No.: US 2021/0225377 A1
(43) Pub. Date: Jul. 22, 2021

(54) METHOD FOR TRANSCRIBING SPOKEN LANGUAGE WITH REAL-TIME GESTURE-BASED FORMATTING

(71) Applicant: Verbz Labs Inc., San Francisco, CA (US)

(72) Inventors: Dexter Zhao, Redwood City, CA (US); Hugh Geiger, Redwood City, CA (US); Matt Laurie, Redwood City, CA (US); Myunghee Lee, Redwood City, CA (US)

(21) Appl. No.: 17/151,511

(22) Filed: Jan. 18, 2021

Related U.S. Application Data
(60) Provisional application No. 62/962,808, filed on Jan. 17, 2020.

(51) Int. Cl. G10L 15/26; G10L 15/22; G06F 40/103; G06F 3/01; G06F 40/174

(52) U.S. Cl. CPC G10L 15/26; G10L 15/22; G06F 40/174; G06F 3/017; G06F 40/103

(57) ABSTRACT

One variation of a method for transcribing spoken language includes: during a first time period, receiving a first gesture from a user at a user interface of a computing device, capturing a first segment of an audio recording during human speech by the user, transcribing the first segment of the audio recording into a first text sequence, and formatting the first text sequence in a first text format according to the first gesture; compiling the first text sequence, in the first format, into a structured textual document; populating the structured textual document with a set of text flags; linking each text flag, in the set of text flags, to a keytime in the audio recording; identifying a recipient of the structured textual document; and transmitting the audio recording and the structured textual document to a second computing device associated with the recipient.

### CROSS-REFERENCE TO RELATED APPLICATIONS

This Application claims the benefit of U.S. Provisional Application No. 62/962,808, filed on 17 Jan. 2020, which is incorporated in its entirety by this reference.

### TECHNICAL FIELD

This invention relates generally to the field of audio transcription and more specifically to a new and useful method for transcribing spoken language with real-time gesture-based formatting in the field of audio transcription.

### BRIEF DESCRIPTION OF THE FIGURES

FIG. 1 is a schematic representations of a method; and

FIG. 2 is a graphical representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

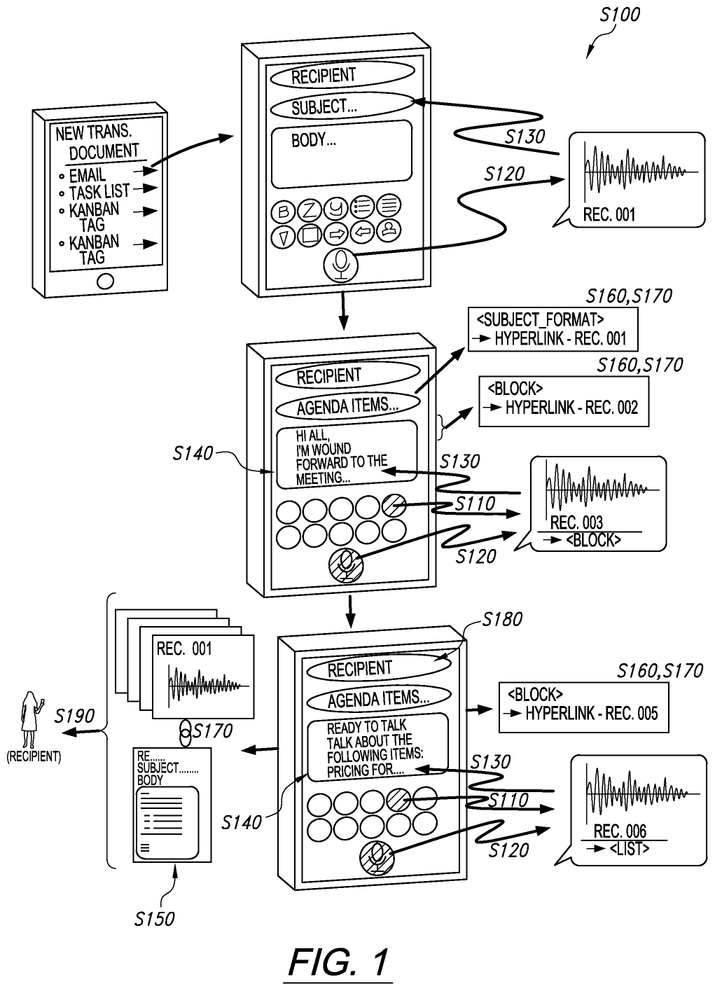

As shown in FIG. 1, a method S100 for transcribing spoken language with real-time gesture-based formatting includes, during a first time period: receiving a first gesture from a user at a user interface of a computing device in Block S110; capturing a first segment of an audio recording during human speech by the user in Block S120; transcribing the first segment of the audio recording into a first text sequence in Block S130; and formatting the first text sequence in a first text format according to the first gesture in Block S140. The method S100 also includes, during a second time period: receiving a second gesture from the user at the user interface in Block S110; capturing a second segment of the audio recording during human speech by the user in Block S120; transcribing the second segment of the audio recording into a second text sequence in Block S130; and formatting the second text sequence in a second text format according to the second gesture in Block S140. The method S100 further includes: compiling the first text sequence, in the first format, and the second text sequence, in the second format, into a structured textual document in Block S150; populating the structured textual document with a set of text flags in Block S160; linking each text flag, in the set of text flags, to a keytime in the audio recording in Block S170; identifying a recipient of the structured textual document in Block S180; and transmitting the audio recording and the structured textual document to a second computing device associated with the recipient in Block S190.

### 2. Applications

Generally, Blocks of the method S100 can be executed by a user's computing device to: ingest speech; transform this speech into a structured textual document—such as an email, a CRM submission, a patient report, a status update, a task list for a coworker or assistant, or a personal task list—without explicit markup by the user; and output this structured textual document paired with an uncorrupted (e.g., authentic, human-understandable) audio recording for later review by a recipient in the event that a word, phrase, or punctuation, etc. in this structured textual document is not immediately understood by the recipient. In particular, the user's computing device can execute Blocks of the method S100 to: derive live text-based formatting and punctuation from a user's verbal input (i.e., human speech)—excluding explicit punctuation or voice commands—based on: implicit formatting techniques for basic grammatical punctuation (e.g., commas, periods); and hand-based gestures on a touch surface of the user's computing device (e.g., a touchscreen in a smartphone or tablet) to select a document type and to trigger a transformation or text format of subsequent transcribed text. The computing device can execute further Blocks of the method S100: to compile words, phrases, text-based formatting, and punctuation thus derived from this verbal input into a structured textual document; to store this structured textual document with an audio recording of this original verbal input, which represents natural human speech by the user, forms a backup or redundant record of the vocal input, and is absent jarring and confusing spoken punctuation or formatting commands; and to return this structured textual document to a recipient indicated by the user.

Furthermore, in the event of transcription errors not corrected by the user or in the event of other unclear content in the structured textual document, the recipient's computing device can retrieve and replay corresponding segments of the audio recording paired with this structured textual document, thereby enabling the recipient to hear the original vocal input from which this erroneous or unclear textual content was transcribed. The user's computing device and the recipient's computing device can therefore cooperate: to enable the recipient to rapidly digest structured textual content—such as in an email, text message, task list, or calendar event—derived from a user's natural speech and in a format appropriate for a type of this textual content; and to access this original natural speech for additional clarity in instances of errors or misunderstanding in this structured textual content.

Generally, human speech lacks implicit punctuation and formatting that makes written language easily digestible and understandable. More specifically, written language is typically more structured than spoken language, such as in professional communications in which writing structures, text formatting, and punctuation enable greater clarity and reduce miscommunication between coworkers, partners, and customers, etc.

Therefore, the computing device can execute Blocks of the method S100: to enable the user to speak a communication for translation into a text; to interface with the user through hand-based gestures—rather than real-time, speech-based explicit markup—to define writing structures, text formatting, and punctuation for this text; and to compile these text and corresponding writing structures, text formatting, and punctuation into a structured textual document that is clear and easily-digestible by a recipient (e.g., a coworker, a partner, and a customer). In particular, the computing device can generate this structured textual document without speech-based explicit markup in which the user interrupts recitation of content of a communication in order to vocalize explicit punctuation, such as “comma,” “new paragraph,” or “new bullet point.” Because explicit markup is not natural in human speech, such dictation techniques may be cumbersome for the user and may require extensive user training or experience for successful transcription. Furthermore, because explicit markup is not natural in human speech, a message or purpose of the speech may be obfuscated from an audio recording containing such explicit markup. More specifically, such explicit markup may corrupt an audio recording of this human speech such that this audio recording cannot adequately function as a backup record of this speech for the purpose of clarifying transcribed content from this human speech, such as in the event of transcription errors.

Conversely, the computing device can implement implicit markup techniques to infer some punctuation from the user's speech, such as by inferring commas and/or periods from pauses and tonalities in human speech. However, such implicit markup may be insufficient to interpret or infer non-verbal punctuation, such as for bullet points, line breaks, and document-level business rules for which verbal cues do not exist in normal human speech.

Rather, by excluding explicit markup from the transcription process and implementing gesture-based formatting and implicit markup controls, the computer system can transcribe live human speech into a structured textual document—fully formatted according to a type of the document—while also preserving authenticity and human-intelligibility of the human speech. More specifically, the computer system can execute Blocks of the method S100 to: leverage implicit formatting techniques to infer basic grammatical punctuation (e.g., commas, periods) and to enable a set of hand-based interactions (or “gestures”) for rapid, real-time formatting and structure controls from human speech without necessitating vocalized punctuation, voice commands, or specialized user training such that the user's speech remains natural while dictating this structured textual document and such that an audio recording of this speech remains understandable for a user if replayed in conjunction with the structured textual document.

Therefore, the user's computer system can execute Blocks of the method S100 to provide more freedom to generate and send a structured textual document transcribed from a vocal input, even if this structured textual document contains word, spelling, or grammatical errors because an audio recording of this vocal input persists as an uncorrupted, human-understandable backup record of the user's intended message in this structured textual document. Similarly, the user's computer system can transcribe this vocal input into a structured textual document in order to enable the recipient of this structured textual document to access this communication in a structured textual format, which may be both searchable and understood quickly (e.g., relative to listening to an audio recording of this vocal input).

Furthermore, the user's computer system can store the structured textual document paired with the audio recording of the corresponding vocal input in order to enable the recipient to refer back to this audio recording in the event that a word or phrase, etc. in the structured textual document was erroneous or not immediately clear to the recipient. For example, the computer system can link words, phrases, and/or elements (e.g., bullets, headings, discrete task elements in a task list) in the structured textual document: to keytimes (e.g., timestamps, time flags) within an audio recording spanning the transcription session for the structured textual document; or to discrete audio snippets recorded throughout this transcription session for the structured textual document. Therefore, if the recipient identifies a word, phrase, or other element in the structured textual document that is unclear while reading this structured textual document at her computing device, the recipient may select this word, phrase, or element from the structured textual document. The recipient's computing device can then: retrieve a snippet of the audio recording corresponding to this word, phrase, or element selected by the recipient; and then replay this audio snippet for the recipient. The recipient's computing device can thus enable the recipient to access the user's original vocal input—without explicit spoken markup—for quick clarification of the user's original intent for this selected textual content in the structured textual document.

The method S100 is described herein as executed locally by a native application installed on a user's computing device, such as a smartphone, tablet, or other mobile device. However, the method S100 can alternatively be executed by a web browser, web plugin, application plugin installed on the user's computing device. Additionally or alternatively, Blocks of the method S100 can be execute by a remote computer system—such as a remote server or other computer network—such as to transcribe audio snippets into text.

### 3. Document Type

In one implementation, a native application renders a user interface and populates a menu in the user interface with a prepopulated menu of document types, such as an email, a CRM submission, a patient report, a status update, a task list for a coworker or assistant, or a personal task list. To start transcription of a vocal input into a new structured textual document, the user may: open the native application; and select a document type from the prepopulated menu in order to initiate a new transcription session. Accordingly, the native application can: initialize a new structured textual document, such as including a prepopulated set of text fields, each assigned an initial format; and retrieve document-level rules for this document type, such as defined within or unique to the user's organization.

For example, in response to the user selecting a new email, the native application can initialize an “email-type” document, including: a “recipient” field; a “carbon copy” field; a “subject” field; and a “body” field. The native application can also insert a stored, formatted signature line at an end of the body field in this email-type document. The native application can also automatically insert a command (e.g., <body_style_1>) for a default text format (e.g., block text in a particular typeface, font, and text color) at the top of the body field in this email-type document.

In another example, in response to the user selecting a new task list, the native application can initialize a “task-list-type” document, including: a “recipient” field; a “list” field; and “deadline” or “date” field. In this example, the native application can also automatically insert a bulleted list command (e.g., <bullet><indent>) into the list field in this task-list-type document.

In yet another example, in response to the user selecting a new virtual kanban tag, the native application can initialize a “kanban-type” document, including: an “owner” field; a “label” or “type” field; a “deadline” field; a “title” field; and a “notes” field. In this example, the native application can also automatically insert a capitalization command (e.g., <caps>) into the title field in this kanban-type document.

However, the native application can support and initialize a structured textual document of any other type at the beginning of a transcription session.

### 4. Audio Recording and Live Transcription

Block S120 of the method S100 recites capturing a first segment of an audio recording during human speech by the user; and Block S130 of the method S100 recites transcribing the first segment of the audio recording into a first text sequence, respectively. Generally, in Blocks S120 and S130, the native application can initiate capture of an audio recording, automatically transcribe human speech detected in this audio recording into text, and write this text to a current field—in the structured textual document.

In one implementation, after initializing the structured textual document, the native application loads a graphical user interface depicting fields of this structured textual document and renders this graphical user interface on a display of the user's computing device. The user then selects a field of the structured textual document, such as by tapping over a representation of this field currently rendered on the display. Responsive to selection of this field, the native application can: initialize an audio recording; initiate transcription of human speech detected in this audio recording; and direct text transcribed from this audio recording into the selected field. Alternatively, in response to selection of a field, the native application can enable a virtual record button rendered on the display and direct text transcribed from a subsequent audio recording into the selected field; the native application can then initialize an audio recording and initiate transcription of human speech detected in this audio recording responsive to selection of this virtual record button.

The native application can then: implement automated transcription techniques with implicit formatting to interpret a sequence of words and speech-based punctuation (e.g., commas, periods) from this audio recording; and render transcribed text and punctuation in the selected field in (near) real-time as the user's computing device ingests and processes this audio recording.

Alternatively, the native application can stream the audio recording back to a remote computer system for remote transcription, which can store a remote copy of this audio recording and return a transcribed sequence of transcribed words or phrases to the user's computing device in (near) real-time. The native application can then populate the selected text field with these transcribed words or phrases.

### 5. Forward Formatting Selection

Block S110 of the method S100 recites receiving a first gesture from a user at a user interface of a computing device; and Block S140 of the method S100 recites formatting the first text sequence in a first text format according to the first gesture. Generally, in Block S140, the native application can format transcribed words or phrases in the field based on a hand-based gesture entered by the user.

In one implementation, the native application renders a menu of input regions (e.g., virtual buttons) corresponding to formatting options available for the selected field in the structured textual document. In this implementation, the native application can also selectively enable these input regions and corresponding format controls based on the document type and field selected. In one example, in a body field in an email-type document, the native application can present a menu of input regions representing controls for: activating and deactivating bold, italics, and underline font formats; switching between preset typeface profiles; switching between block text, a numerical list, an alphabetical list, and a bulleted list; and increasing or decreasing indentation. In this example, the native application can present input regions for a similar combination of input regions for a notes or agenda field in a calendar-event-type document. In another example, in a calendar-type document, the native application can present a menu of input regions representing controls for: activating a location format (e.g., including an address, GPS location, and/or hyperlink; activating a date format; and selecting invitees. In yet another example, in a subject field in an email-type document, the native application can: disable input regions representing controls for font and typeface controls, activating lists; selecting a recipient; and inserting a hyperlink; but preserve input regions representing controls for activating location and date format.

In the foregoing examples, the native application can render this dynamic ribbon or row of virtual buttons proximal a lower edge of the display of the computing device such that these virtual buttons are reachable with a hand, finger, or stylus while the user holds the computing device.

In another implementation, the native application implements touch-based gestures to selectively activate and deactivate formatting within the current field. In one example, in a body field in an email-type document (and a notes or agenda field in a calendar-event-type document, etc.), the native application can: interpret a double-tap on the display of the computing device as a line return command; interpret an upward swipe on the display of the computing device as a bold font activation command; interpret a downward swipe on the display of the computing device as a command to start a next paragraph; interpret a rightward swipe on the display of the computing device as an indent command; and interpret a tap and hold input on the display of the computing device as a command to toggle a bulleted list in this body field. In another example, in a body field in a task-list-type document, the native application can: interpret a double-tap on the display of the computing device as a command to create a next element in a list; interpret an upward swipe on the display of the computing device as a bold font activation command; interpret a rightward swipe on the display of the computing device as a command to activate a sub-list under a last element in the current list; and interpret a tap and hold input on the display of the computing device as a command to toggle between a bulleted, numbered, and lettered list in this body field.

Therefore, soon before or soon after selecting a field in the structured textual document and initiating recordation of an audio recording for this field, the user may: consider what she is about to say; and select a format—from a menu of formatting options thus presented by the native application or through another gesture input—that the user deems appropriate for the communication she is about to speak. Upon receipt of a formatting selection, the native application can: write a command corresponding to the formatting selection to the current field; populate this field with text transcribed from the subsequent audio communication; and render this transcribed text according to this format on the computing device's display.

In one example, the user elects an email-type document to initialize a new transcription session and selects the body field of this email-type document to initiate capture of an audio recording. The native application can then load a block text command (e.g., <block>) into this body field by default; write a first sequence of text subsequently transcribed from speech detected in the audio recording to this body field following the block text command; and render this first sequence of text in the block text format in the body field. Later, when the user selects a “list” input region or enters a gesture associated with list insertion over the display of the computing device, the native application can: write a command (e.g., <block>or <block_end>) following the first sequence of text to close the preceding block format; write a next command (e.g., <list> or <list_start>) to initiate a list format in the body field; write a second sequence of text subsequently transcribed from speech detected in the audio recording to this body field following the list command; and render this second sequence of text in the list format below the first sequence of text in the block format in the body field.

Furthermore, in the foregoing example, when the user selects a “bold” input region or enters a gesture associated with bold text over the display of the computing device, the native application can: write a bold command (e.g., <bold>) to initiate an emboldened format; and format all text transcribed from subsequent speech detected in the audio recording—up to completion of dictation of this field or up to a next formatting change entered by the user—as emboldened and in the current list format. When the user later reselects the “bold” input region or enters the corresponding gesture, the native application can write a command (e.g., <bold>) to return to an unemboldened format for all text transcribed from subsequent speech detected in the audio recording—up to completion of dictation of this field or up to a next formatting change entered by the user during this transcription session.

When the user later selects a “block text” input region or enters a gesture associated with block text insertion over the display of the computing device, the native application can: write a command (e.g., <list> or <list_end>) to close the preceding list format; write a next command (e.g., <block> or <block_start>) to initiate a next block text format; write a third sequence of text subsequently transcribed from speech detected in the audio recording to this body field following the block text command; and render this third sequence of text in the block text format below the second sequence of text in the list format in the body field.

However, the native application can implement any other method or technique to transcribe speech detected in an audio recording and to record formatting commands entered through hand-based gestures before or during capture of this audio recording.

### 6. Real-Time Retroactive Formatting Change

In one variation, the native application inserts formatting commands into the current field in the structured textual document based on features detected in the vocal input and/or based on gestures entered by the user.

In one implementation, the native application: captures an audio recording continuously during dictation of a field in the structured textual document (or over the entirety of the transcription session); detects pauses and/or hesitations (e.g., “um”) in the vocal input in this audio recording; and delineates audio segments—bounded on each end by a pause or hesitation—from the audio recording. (In this implementation, the native application can also extract these segments from the audio recording and store these audio segments as discrete audio snippets, as described below.) As described above, the user may pause dictation as she considers what she is about to say and then select a format for this transcribed speech before speaking. Thus, in response to a formatting input entered by the user during a detected pause, the native application can insert a corresponding formatting command into the current field in the structured textual document in order to define a format for subsequent text transcribed from subsequent speech—up to completion of dictation of this field or up to a next formatting change entered by the user.

However, if the user enters a formatting input while speaking or during a hesitation, the user may have identified a need for a formatting change for recently-transcribed text while viewing this transcribed text now rendered on her computing device. Accordingly, the computing device can retroactively update preceding transcribed text according to this formatting input. For example, in response to the user selecting a formatting command while speech is detected in the audio recording, the native application can insert a command for this formatting input between two consecutive transcribed words—in the current field in the structured textual document—spanning a last pause in the vocal input detected in the audio recording. The native application can then update text rendered in the text field according to this formatting command retroactively placed in text in the current field in the structured textual document.

### 7. Other Fields

When the user later releases the virtual record button, selects the virtual record button, or selects an alternate field in the current document type, the native application can cease capture of the current audio recording and cease transcription of text from this audio recording into the current field in the audio recording. The native application can then implement methods and techniques described above to capture audio recordings (or audio snippets) linked to other fields in the structured textual document, to insert formatting commands into these other fields, and to populate these other fields with transcribed text.

### 8. Text-to-Audio Links

Therefore, the native application can capture a continuous audio recording spanning complete dictation of a field in the structured textual document, transcribe this audio recording into text, record gesture-based formatting commands during dictation of the field, and render this transcribed—text formatting according to these formatting commands—in (near) real-time on a display of the user's computing device. The native application can also link segments or snippets of this audio recording to words, phrases, or other elements in this field.

In one implementation, the native application links each transcribed word in a field in the structured textual document to a timestamp—in the audio recording—at a start of recitation of this word by the user during dictation of this field. For example, the native application can write a hyperlink to each transcribed word in this field, wherein each hyperlink: navigates to a copy of the audio recording (or an audio snippet extracted from this audio recording); seeks to keytime in this audio recording just before recitation of this word by the user; and triggers playback of the audio recording forward from this keytime. Thus, in this example, when the recipient of the structured textual document views this field at her computing device and finds an error or confusing word or phrase in this transcribed text, the recipient may select this erroneous or confusing word from the field. Accordingly, her computing device may: open a web browser; navigate to a hyperlink—stored with this word—in the web browser; and playback a stored audio recording forward from the keytime linked to this selected word. Alternatively, in one variation in which the native application transmits the structured textual document with the audio recording (or audio snippets) captured during the transcription session, the recipient's computing device can: open an audio player; load the audio recording into the audio player; seek forward to a start time preceding the keytime—linked to the word selected by the user—by a buffer time (e.g., three seconds); and initiate playback forward from this keytime, thereby enabling the user to hear this word in the context of nearby concepts dictated by the user.

In another implementation, the native application: detects pauses in the audio recording as user dictates content for a field in the structured textual document; segments this audio recording into a sequence of audio snippets separated by these pauses (and by formatting input entered by the user); and stores each audio snippet as a separate audio file linked to this field in this structured textual document. For a first audio snippet in this set, the native application can then: identify a first contiguous sequence of words transcribed from this first audio snippet into the field; and link this first contiguous sequence of words to the first audio snippet. The native application can repeat this process for each other audio snippet associated with this field. Thus, in this implementation, when the recipient of the structured textual document views this field at her computing device and finds an error or confusing word or phrase in this transcribed text, the recipient may select an erroneous or confusing group of words from this field. Accordingly, her computing device may: open a web browser; navigate to a hyperlink—associated with this group of words—in the web browser; and playback a stored audio snippet linked to this selected group of words. Alternatively, in one variation in which the native application transmits the structured textual document with the audio recording (or audio snippets) captured during the transcription session, the recipient's computing device can: open an audio player; load the audio snippet associated with this group of words into the audio player; and initiate playback of this audio snippet.

In a similar implementation, the native application can: detect pauses in the audio recording as the user dictates content of a field in the structured textual document; and define discrete vocal inputs separated by pauses in the audio recording. For a first vocal input in this set, the native application can: identify a first contiguous sequence of words in the field transcribed from this first vocal input; and link this first contiguous sequence of transcribed words to a first timestamp—in the audio recording—at a start of the corresponding vocal input. Thus, in this implementation, when viewing this field in the structured textual document at her computing device, the recipient may select an erroneous or confusing word or phrase in this field. Accordingly, her device may: open an audio player; load the complete audio recording for this field; seek to the timestamp associated with a start of this sequence of words in the field; and initiate playback of the audio recording forward from this timestamp.

In another implementation, the native application delineates sequences of words or phrases—transcribed into a field in the structured textual document—by format. For example, the native application can segment transcribed text by: one list element in a list; one sentence in a text block; one name in a recipient field; and one date in a date field. The native application can then: extract discrete audio snippets—from the audio recording for a field—corresponding to each element segmented from transcribed text in this field; and link one audio segment to each element in this field. Thus, in this implementation, when viewing this field in the structured textual document at her computing device, the recipient may select an erroneous or confusing element in this field. Accordingly, her device may: open an audio player; load the audio snippet associated with this element in this field; and initiate playback of this audio snippet.

However, the native application can: delineate words, phrases, or elements in a field in the structured textual document according to any other schema; and can link these words, phrases, or elements to whole audio snippets, to keytimes in audio snippets, or to keytimes in a complete audio recording, etc. in any other way.

### 9. Post-Hoc Correction

In one variation, the native application further interfaces with the user to manually edit or correct transcribed text and formatting within each field of the structured textual document, such as upon conclusion of dictation and prior to releasing the structured textual document to the recipient.

### 10. Recipient and Document-Level Rules

The native application can interface with the user according to methods and techniques described above to transcribe a name, phone number, email address, or other identifier or address—of a recipient designated to receive the structured textual document—into a recipient field in the structured textual document. Alternatively, the user may manually select the recipient from an address book. Yet alternatively, if the user is generating the structured textual document in response to a previous inbound communication, the native application can load a sender of this previous inbound communication as a recipient of the structured textual document.

In another variation, the user may specify a destination of the structured textual document—such as a digital kanban board, CRM tool, health record system, or a personal task manager—rather than specify a particular recipient of the structured textual document. Thus, in this variation, a viewer (e.g., the user, a coworker, a client, a partner) may access this structured textual document at its specified destination via a computing device. This computing device can implement methods and techniques similar to those described above to access and playback an audio recording or audio snippet corresponding to erroneous or confusing words, phrases, or elements selected from this structured textual document by the viewer.

Furthermore, the computer system can verify that other document level rules associated with this document type have been met, such as: entry of a recipient email address for an email-type document; entry of a due date for a kanban-type document; or a character limit for a text message- type document. The computer system can prompt the user to correct any such rule errors before enabling distribution of the document to the recipient(s).

### 11. Transmission

Once the user confirms the structured textual document is complete and selects a recipient for the structured textual document, the native application can initiate transmission of the structured textual document to the recipient. (Similarly, once the user confirms the structured textual document is complete and selects a destination for the structured textual document, the native application can initiate upload of the structured textual document to its specified destination.)

In one implementation, the native application transmits both the structured textual document and the audio recording (or audio snippets)—linked to the structured textual document—to the recipient's address (e.g., to an email account, phone number, messaging account within a messaging platform, electronic calendar, electronic kanban board associated with the recipient). Later, when presenting this structured textual document to the recipient, the recipient's computing device may replay segments of the audio recording from a local copy of the audio recording (or audio snippets) responsive to selection of words, phrases, or other elements that the recipient perceives as confusing or possibly erroneous in the structured textual document.

In another implementation, the native application transmits the structured textual document to the recipient and uploads the audio recording (or audio snippets)—linked to the structured textual document—to a remote database for storage. Thus, in this implementation, when presenting the structured textual document to the recipient, the recipient's computing device may selectively query the remote database for the audio recording as a whole (or for specific audio snippets) and replay segments or this audio recording (or audio snippets) responsive to selection of words, phrases, or other elements that the recipient perceives as confusing or possibly erroneous in the structured textual document.

In one variation, the user's computing device calculates a confidence score for accuracy of transcription of the vocal input, such as: based on an aggregate of individual confidence scores that the computing device (or a remote computer system) accurately interpreted each individual word in the vocal input; and based on whether the user manually corrected any of these words or phrases (which may correspond to 1.0000 confidence in transcription accuracy for these manually-corrected words and phrases). Then, if this confidence score is less than a threshold score (e.g., 80%) when the user confirms completion of the structured textual document, the computing device can automatically transmit both the structured textual document and the audio recording (or audio snippets) to the recipient, thereby enabling the recipient to quickly access the audio recording (or audio snippets) that the recipient is likely to need to fully comprehend the structured textual document given the lower confidence in accuracy of this transcription. Conversely, if this confidence score is greater than the threshold score when the user confirms completion of the structured textual document, the computing device can transmit the structured textual document only to the recipient and upload the audio recording (or audio snippets) to the remote database for longer-term storage, thereby reducing bandwidth and data download costs for the recipient's computing device while still preserving the recipient's long-term access to this audio recording (or audio snippets).

In another variation, for document types that support multimedia (e.g., a MMS text message, an email, a kanban tag), the native application selectively transmits a structured textual document paired with its audio recording (or corresponding audio snippets) directly to the recipient. Conversely, for a document type that does not support multimedia (e.g., a SMS text message, a calendar event), the native application can: populate words, phrases, or elements in a structured textual document with hyperlinks to audio snippets extracted from this audio recording or to keytimes in the audio recording; transmit the structured textual document—with these hyperlinks—to the recipient; and store the audio recording (or audio snippets) in the remote database. In this implementation, the recipient's computing device can therefore access segments of the audio recording corresponding to erroneous or confusing textual content in the structured textual document by selecting a word, phrase, or element containing a hyperlink, which may trigger a web browser executing on the recipient's computing device to navigate to this hyperlink, to access the audio recording or a corresponding audio snippet, and to replay this audio content accordingly.

However, the native application can package and offload the structured textual document and audio recording (or audio snippets) in any other way and according to any other schema.

### 12. Example

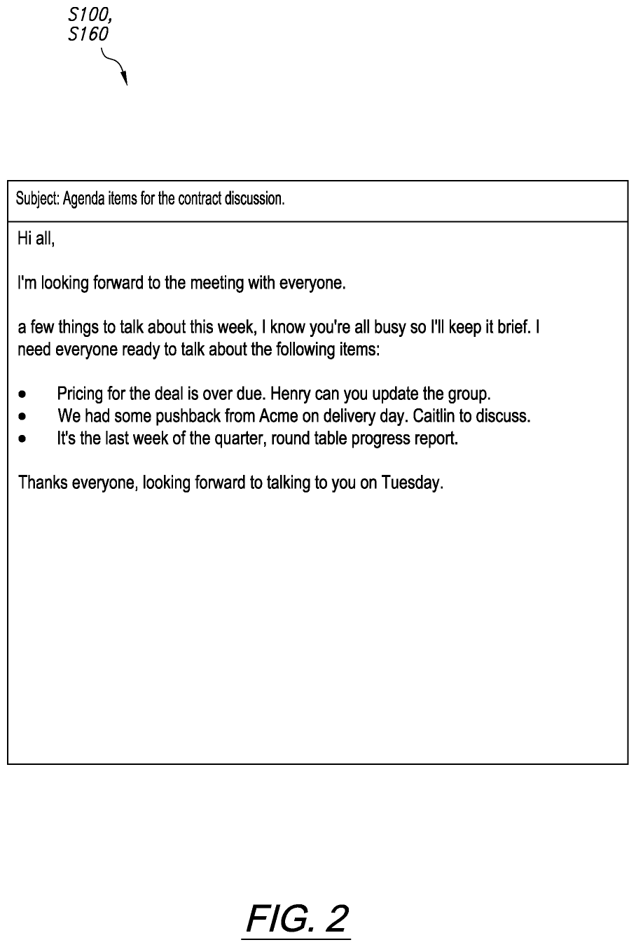

In one example shown in FIGS. 1 and 2, the user may: select an email-type document; tap a subject field in this email-type document; select a virtual record button to activate transcription into the subject field; then speak, “Agenda items for the contract discussion.” The native application then: captures an audio recording of the vocal input; transcribes this audio recording into a sequence of words or phrases including “agenda items for the contract discussion,” and populates the subject field in this email-type document accordingly until the user taps the subject field a second time to finalize this audio recording and the subject field. (Alternatively, the native application can stream this audio recording to the remote computer system for remote transcription, and the remote computer system can store a remote copy of this audio recording and return the corresponding sequence of transcribed words or phrases to the native application for insertion into this subject field.) The native application can also store this audio recording as a discrete audio file linked to this title field for this structured textual document.

In this example, the user may then tap a body field in the email-type document to initiate a next audio recording and transcription of textual content into this body field. The user then: taps a block text button within the body field; selects the virtual record button; says, “Hi Everyone”; and reselects the virtual record button to close this first audio recording for the body field. The user: pauses for breath; selects the virtual record button to trigger a line break and initiate further transcription in the body field; says, “I'm looking forward to the meeting with everyone”; and reselects the virtual record button to close this second audio recording for the body field. The user again: pauses for breath; selects the virtual record button to trigger a next line break and initiate further transcription in the body field; says, “A few things to talk about this week, I know everyone is busy so I'll keep it brief”; and reselects the virtual record button to close this third audio recording for the body field. The user then: pauses for breath; selects the virtual record button; select a ‘continuation’ format button to continue transcription in the current line without a line break; says, “I need everyone prepared to discuss the following items”; and reselects the virtual record button to close this fourth audio recording for the body field. The user: pauses for breath; selects a ‘bullet list’ format button to initiate a first element in a bulleted list; selects the record button; says, “Pricing for the deal is over due. Henry can you update the group”; and reselects the virtual record button to close this fourth audio recording for the body field. The user further: pauses for breath; selects the virtual record button to trigger a next element in the bulleted list and initiate further transcription in the body field; says “We had some pushback from Acme on deliver day. Caitlin to discuss”; and reselects the virtual record button to close this fifth audio recording for the body field. Similarly, the user then: pauses for breath; selects the virtual record button to trigger a third element in the bulleted list and initiate further transcription in the body field; says “It's the last week of the quarter, round table progress report”; and reselects the virtual record button to close this sixth audio recording for the body field. The user again: pauses for breath; selects the virtual block text button to initiate block text and to close the preceding bulleted list in the body field; selects the virtual record button to trigger a line break and initiate further transcription in block text format in the body field; says, “Thanks everyone, looking forward to talking to you on Tuesday”; and reselects the virtual record button to close this seventh audio recording for the body field. Finally, the user selects a virtual confirm button to complete dictation into the body field in this email-type document, which triggers the native application to insert a preformatted signature line at the end of transcribed text in this body field.

In this example, the native application can transcribe these audio recordings and format this transcribed text as shown in FIG. 2.

The native application can then repeat the foregoing methods and techniques to capture and transcribe this next audio recording, to populate the body field in this email-type document with transcribed text and formatting commands, and to store this next audio recording as a second discrete audio file linked to this body field for this structured textual document.

Furthermore, in this implementation, the native application can link each of the seven audio recordings—captured by the native application during transcription of the body of this email-type document—to a corresponding phrase, sentence, or element in this body field.

When later viewing this email-type document, a recipient may perceive a particular word, phrase, or element in this email-type document as erroneous or desire verification of accuracy of this word, phrase, or element. Accordingly, the recipient may select this particular word, phrase, or element at her computing device. The recipient's computing device can then retrieve a particular audio recording linked to this word, phrase, or element and automatically playback this particular audio recording for the recipient.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for transcribing spoken language includes:
during a first time period:
receiving a first gesture from a user at a user interface of a computing device;
capturing a first segment of an audio recording during human speech by the user;
transcribing the first segment of the audio recording into a first text sequence;
formatting the first text sequence in a first text format according to the first gesture;
during a second time period:
receiving a second gesture from the user at the user interface;
capturing a second segment of the audio recording during human speech by the user;
transcribing the second segment of the audio recording into a second text sequence;
formatting the second text sequence in a second text format according to the second gesture;
compiling the first text sequence, in the first format, and the second text sequence, in the second format, into a structured textual document;
populating the structured textual document with a set of text flags;
linking each text flag, in the set of text flags, to a keytime in the audio recording;
identifying a recipient of the structured textual document; and
transmitting the audio recording and the structured textual document to a second computing device associated with the recipient.
